(19) United States
(12) Patent Application Publication
(10) Pub. No.: US 2025/0377315 A1
(43) Pub. Date: Dec. 11, 2025

(54) X-RAY SCANNING OF PIPE GASKETS

(71) Applicant: Xray Center Guvenlik Sistemleri A.S., Beylikduzu/Istanbul (TR)

(72) Inventor: Mikael Havluciyan, La Mesa, CA (US)

(21) Appl. No.: 19/092,829

(22) Filed: Mar. 27, 2025

Related U.S. Application Data
(63) Continuation of application No. PCT/US23/35037, filed on Oct. 12, 2023.
(60) Provisional application No. 63/416,171, filed on Oct. 14, 2022.

(51) Int. Cl. G01N 23/04; G01N 23/083

(52) U.S. Cl. CPC G01N 23/04; G01N 23/083; G01N 2223/316; G01N 2223/3306; G01N 2223/628

(57) ABSTRACT

An x-ray scanner for non-destructive inspection of gaskets on pipes is provided. The x-ray scanner has a carriage with a hemispherical cut-out opening sized to receive an open end of a pipe. The carriage also forms a housing that contains an x-ray generator, a computer that controls the operation of the x-ray scanner, and a cantilever extending from the top of a support structure. The cantilever has mounted on its bottom side an x-ray detector board including an x-ray sensor. The cantilever is positioned in the hemispherical cut-out, and the x-ray generator is below the cantilever and aligned with the x-ray sensor on the detector board.

### CROSS-REFERENCE TO RELATED APPLICATIONS

This application is a continuation of PCT Application No. PCT/US23/35037 filed Oct. 12, 2023, which claims priority to U.S. Provisional Application No. 63/416,171, filed Oct. 14, 2022.

### FIELD

The present disclosure relates generally to inspection systems and, in particular, to nondestructive inspection of pipes and other fluid transport vessels. Still more particularly, the present disclosure relates to a method, apparatus and system for non-destructive quality control inspection of gaskets, such as rubber and plastic gaskets used in joints that connect successive pipes in a fluid tight manner.

### BACKGROUND

Pipes are used in many industries and for many purposes. For example, pipes are used to transport oil and can be made from steel or plastic. Pipes are also used to transport natural gas and can be made of carbon steel. Pipes can also be used to transport hot and/or cold water to customers for drinking and usage by companies and homes, and these pipes can be made from many different materials, including composite materials such as GRP (glass fiber reinforced plastics), steel, concrete, copper, and other materials.

In order to transport fluid over long distances, pipes need to be manufactured in sections, which are then connected to one another to form long pipelines. Pipelines can be pressurized or non-pressurized. For example, oil and gas pipelines are pressurized as are water pipelines that transport clean water to businesses and homes, and these pipelines use pumps to transport the gas, oil, water, etc. and they require very durable fluid tight sealing at the connections between one pipe and the next pipe (the joints). Non-pressurized pipelines including ones used for sewage and waste flow, and these types of pipes still require fluid tight sealing at the connections between the pipes so as not to allow for sewage leakage.

All of these types of industrial pipes can be various diameters with large infrastructure pipes being as large as 4000 mm or more. All of these types of pipes require rubber gaskets at their joints in order to prevent fluid leakage at the joints that connect one pipe to another. These gaskets can be made of different kinds of rubber, which are useful for different kinds of applications. For example, one type of rubber that is often used for large industrial pressurized water pipes is EPDM rubber, because it is known to be a very durable water proof material. The rubber gaskets are usually placed in grooves on the luminal (inner) surface of the pipe at the end/joint of the pipe. The rubber gaskets can also be placed in grooves on the outer wall of the pipe at the end/joint of the pipe. Whether the gaskets are placed on the inner luminal surface or the outer surface of the pipes, they form the main barrier to leakage of fluid at the joints of the pipes. Thus, it is imperative that the gaskets are free of any defects and are placed perfectly. Any defects or anomalies in the gaskets or their placement at the joints can result in leakage, and leakage can have many negative consequences, including environmental consequences, health consequences, and financial consequences.

Quality control of pipes is performed in different ways, including visual inspections, videographic inspections, and other forms of non-destructive testing. However, to date there has not been a means of performing very detailed non-destructing inspection of the rubber gaskets once they have been placed in or on the pipe joints. Visual and videographic inspections are inadequate to provide the level of detailed analysis of the condition and proper placement of the rubber gaskets. For that reasons, there is a need for new methods, apparatus and systems for high quality, detailed, non-destructive inspection and testing of rubber gaskets already placed on the joints of pipes.

### SUMMARY

One object of the invention is to provide an x-ray scanner for non-destructive inspection of gaskets on pipes. The x-ray scanner has a carriage with a front side, and a back side with a hemispherical cut-out opening sized to receive an open end of a pipe. The carriage also forms a housing that contains an x-ray generator, a computer that controls the operation of the x-ray scanner, and a cantilever extending from the top of a support structure. The cantilever has mounted on its bottom side an x-ray detector board including an x-ray sensor. The cantilever is positioned in the hemispherical cut-out, and the x-ray generator is below the cantilever and aligned with the x-ray sensor on the detector board. A collimator is connected to the x-ray generator and directs x-ray energy upward to the x-ray sensor on the x-ray detector board. There is sufficient space in between the bottom of the cantilever and the top of the collimator to receive a wall of the pipe, such that energy emitted by the x-ray generator is transmitted through the wall of the pipe and is received by the x-ray sensor on the bottom of the cantilever, said x-ray sensor being positioned inside the lumen of the pipe just above a gasket encircling the inner wall of the pipe. The detector board is in communication with the computer, which contains software that converts data received from the detector board into radiographic x-ray images of the gasket being inspected.

Another object of the invention is to provide an x-ray scanning system for non-destructive inspection of gaskets on pipes. The system includes an x-ray scanner, an axial rotation apparatus, and a remote viewing and control station. The x-ray scanner has a carriage with a front side, and a back side with a hemispherical cut-out opening sized to receive an open end of a pipe. The carriage also forms a housing that contains an x-ray generator, a computer that controls the operation of the x-ray scanner, and a cantilever extending from the top of a support structure. The cantilever has mounted on its bottom side an x-ray detector board including an x-ray sensor. The cantilever is positioned in the hemispherical cut-out, and the x-ray generator is below the cantilever and aligned with the x-ray sensor on the detector board. A collimator is connected to the x-ray generator and directs x-ray energy upward to the x-ray sensor on the x-ray detector board. There is sufficient space in between the bottom of the cantilever and the top of the collimator to receive a wall of the pipe, such that energy emitted by the x-ray generator is transmitted through the wall of the pipe and is received by the x-ray sensor on the bottom of the cantilever, said x-ray sensor being positioned inside the lumen of the pipe just above a gasket encircling the inner wall of the pipe. The detector board is in communication with the computer, which contains software that converts data received from the detector board into radiographic x-ray images of the gasket being inspected. The axial rotation apparatus contains a support structure that supports rollers on which a pipe can rest. The rollers are connected to a motor, which is controlled by the remote viewing and control station and is synced with the x-ray generator, such that the rollers can start rolling after the x-ray generator is turned on, and they stop rolling after the pipe has rotated 360°, thus imaging the entire length of a gasket placed on an inner wall of the pipe. The x-ray scanner, axial rotation apparatus and remote viewing and control station are all in communication with one another.

Other objects and advantages of the present invention will become apparent from the following descriptions, taken in connection with the accompanying drawings, wherein, by way of illustration and example, various embodiments of the present invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a pipe gasket inspection system.

FIG. 2 is a perspective view of an x-ray scanner of the pipe gasket inspection system of FIG. 1.

FIG. 3 is an exploded view of the x-ray scanner of FIG. 2.

FIG. 4 provides two additional perspective views of the x-ray scanner of FIG. 2.

FIG. 5 provides another perspective view looking from the bottom up toward a detection element of the x-ray scanner of FIG. 2.

### DETAILED DESCRIPTION

Exemplary embodiments of the invention are shown in the accompanying figures and described below.

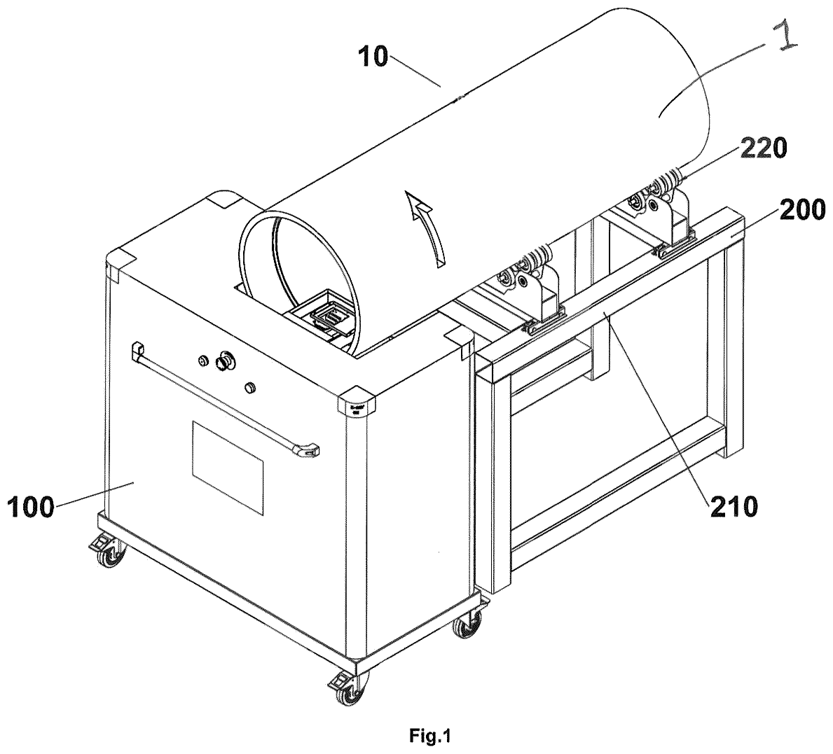

A pipe gasket inspection (PGI) system 10 is depicted in FIG. 1. PGI 10 includes an x-ray scanner 100 forming a housing with a front side and a back side. The back side has a hemispherical cut-out opening 190 designed to receive the end of a pipe, such as pipe 1. PGI 10 also includes an axial rotation apparatus 200 to spin pipe 1 at a known RPM (rotations per minute) when triggered to do so. Axial rotation apparatus 200 includes a support structure 210 that supports rollers 220 that carry pipe 1. A motor (now shown) is connected to rollers 220 and causes rollers 220 to spin, which causes pipe 1 to rotate axially at a known RPM. The motor is in electrical communication with a controller (not shown) that controls the operation of rollers 220. The controller communicates with computer 110 that acts as the central processing unit of scanner 100 and PGI 10 as a whole.

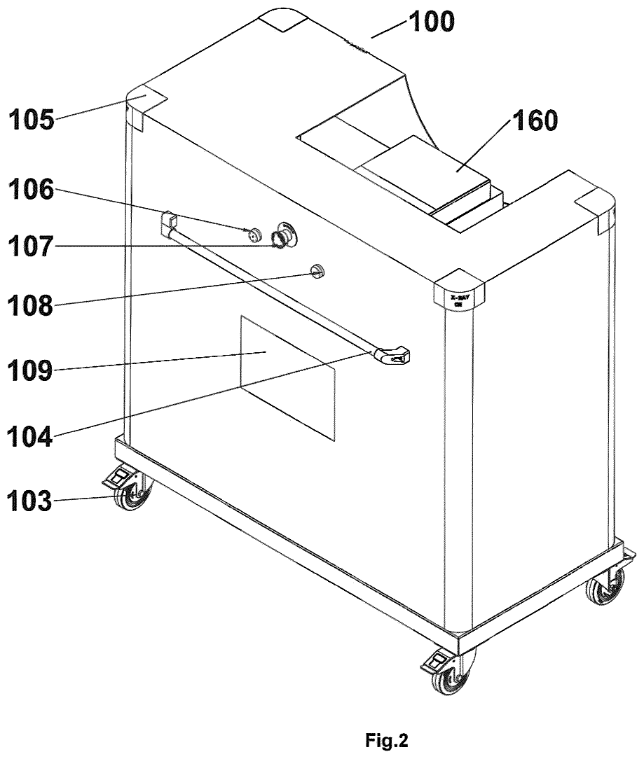

FIG. 2 shows the x-ray scanner 100, which is adapted for scanning gaskets on or in pipes. X-ray scanner 100 can be a mobile carriage that contains all of the electronics and equipment necessary to conduct x-ray scans of gaskets on or in pipes. X-ray scanner 100 can be a carriage as shown in FIG. 2 having wheels 103 so that the carriage is mobile and can be moved from one location to another with ease. The front side of x-ray scanner 100 can include a handle 104 to be able to easily move the carriage by pulling it or pushing it from one location to another. X-ray scanner 100 can include x-ray indicator lights 105 that indicate when the x-ray generator is on and emitting x-ray energy. This is important to signal to operators that they should not be near the x-ray scanner. X-ray scanner 100 also includes an emergency stop button 107 to turn off the x-ray generator quickly. X-ray scanner 100 can include a “system ready” light indicator 106 that indicates that the system is ready for operation and the x-ray generator is not on. The x-ray scanner can also include a system warning light 108, that indicates that there is a problem with the system. X-ray scanner 100 can also have an operator console 109, which can be a touch-screen console or an open/close adjustable i-stand with display unit to display radiographic images depicting the gaskets being scanned. A touch-screen console can also be a display unit to display radiographic images depicting the gaskets being scanned. Alternatively or in addition, x-ray scanner 100 can be in communication (either wired or wireless) with a remote operator control station that is away from the x-ray generator source and in a safe location that doesn't receive any x-ray energy. The remote operator control station can include operator controls to turn on, turn off, and adjust the speed of rollers 220, as well as turn on and off the x-ray generator of x-ray scanner 100. The control station can be programmable for various features, including programming the diameter of the tube that is being inspected, and including a feature that automatically turns off rollers 220 once the tube has been rotated 360°. Thus, an auto-off feature can be included in the system that causes rollers to rotate the inspected tube 360° and then stop. The control station can include a feature that causes the rollers to rotate in either direction, thus being able to reverse the rotation of the inspected tube.

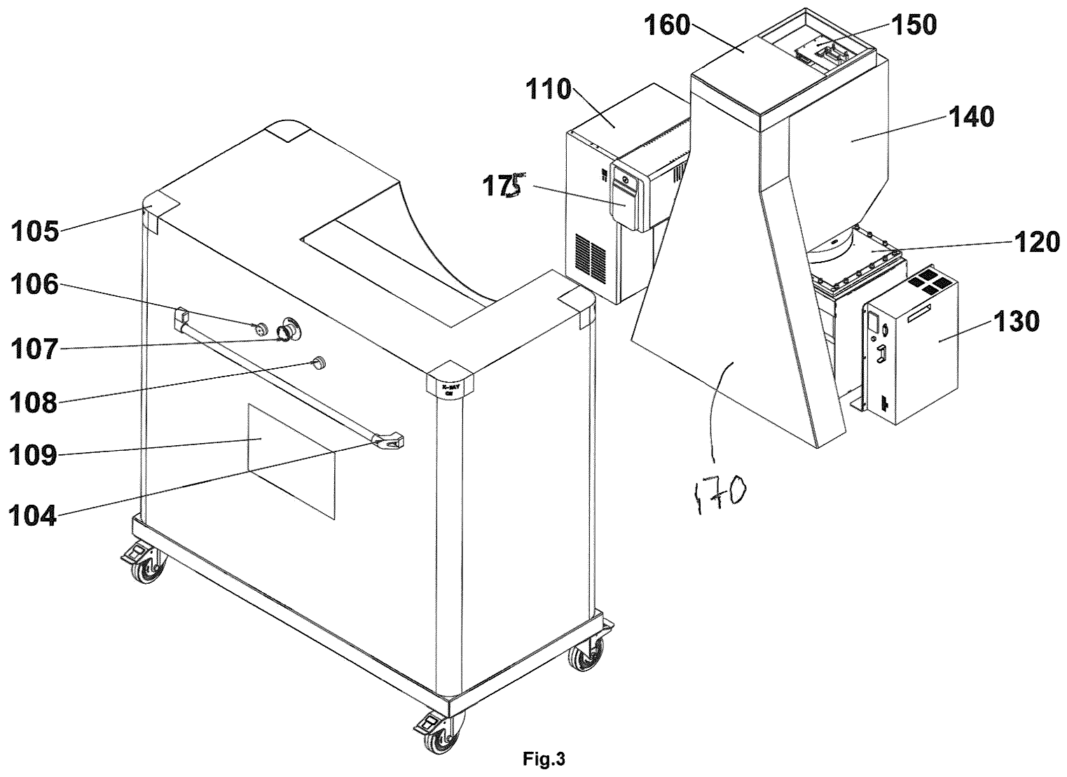

FIG. 3 is an exploded view of x-ray scanner 100. It shows the electronic components and generator source that are part of x-ray scanner 100. X-ray scanner 100 can include a computer 110 that controls the operation of the x-ray scanner and contains and runs the software that controls x-ray scanner and contains all of the imaging and operational software and features of x-ray scanner 100. All of the different functions are contained in the software that is run by the central processing unit, which is part of the computer 110. The software includes code for converting data received from detector board 150 into radiographic x-ray images of the gasket being inspected. X-ray scanner 100 includes x-ray generator 120 and x-ray generator control box 130, which is needed for control of x-ray generator 120. A universal power supply 175 can also be included in order to maintain operation even if the main power supply is compromised. X-ray generator 120 generates x-ray energy that penetrates the piper and gasket, reaches the x-ray sensor on the detector board 150, which data is transmitted to the computer, the software of which converts the data into radiographic images of the gasket that's in or on the pipe. X-ray scanner 100 can also include a collimator 140 that directs x-ray beams narrowly at the x-ray detector board 150 containing an x-ray sensor such as an x-ray detector diode or detector diode array. The x-ray sensor on the x-ray detector board 150 detects the x-ray energy remaining after x-ray beams pass through different materials, creating radiographic images of the materials. Detector board 150 is mounted on a cantilever 160 that extends from support structure 170. Detector board 150 is at the distal end of cantilever 160, while the proximal end of cantilever 160 is securely connected to the top of support structure 170. Support structure 170 can be height adjustable to adjust the height of cantilever 160. Collimator 140 is positioned so that x-ray beams generated by the x-ray generator are directed precisely to the x-ray sensor that is part of x-ray detector board 150. Thus, collimator 140 is below detector board 150 and separated from board 150 by slightly more than the thickness of the walls of the pipes that are intended to be inspected by x-ray scanner 100. For example, if the thickness of the walls of the pipes being inspected is 100 mm, then the distance between the top end of collimator 140 and detector board 150 is more than 100 mm so as to have enough room to receive the wall of the pipe to be inspected. The power of x-ray generator 120 depends on the thickness of the walls and material of the pipes being scanned. For example, if the pipe is made of 10 mm thick steel, then 100 kV generator is generally sufficient to penetrate the steel wall and create an image of the gasket inside the lumen of the steel pipe. For thicker pipes, larger generators, such as 170 kV, 200 kV, or even larger generators can be used.

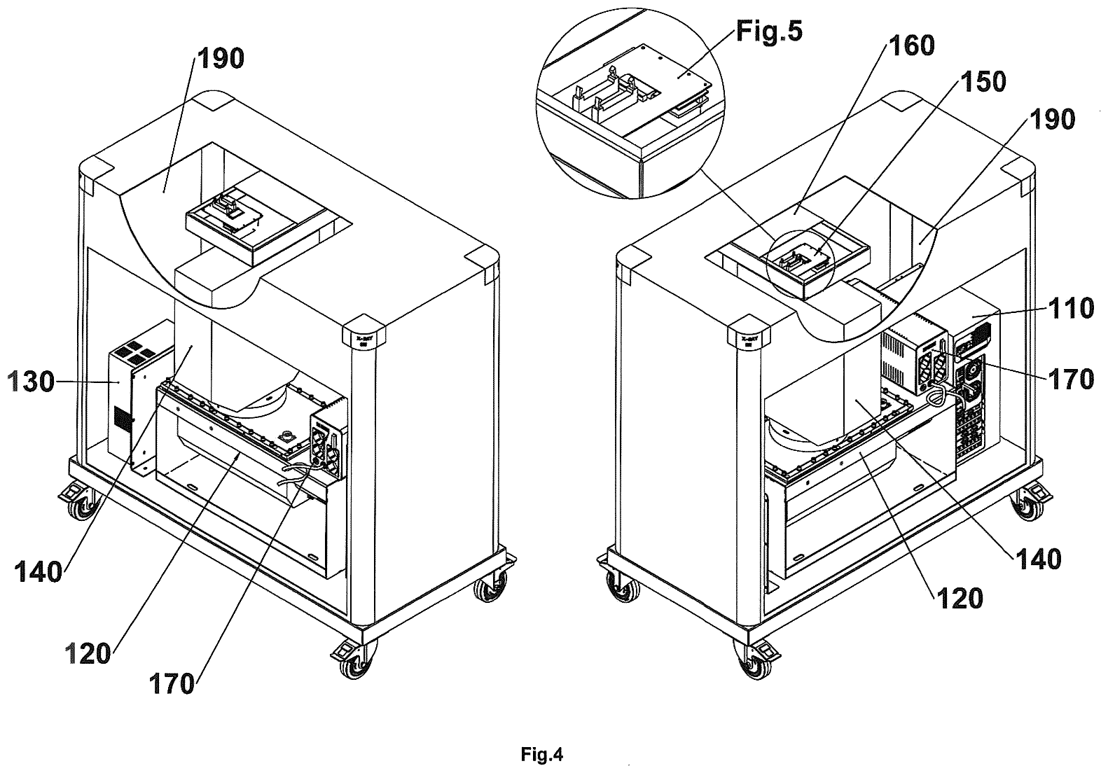

FIG. 4 shows all of the aforementioned components within the carriage of x-ray scanner 100. The wall of the carriage is removed so that the inner components can be seen. One critical feature of x-ray scanner is that it contains a hemispherical cut-out opening 190 that receives the end of a pipe as shown in FIG. 1. The pipe rests atop rollers 220 and the carriage of x-ray scanner 100 is rolled toward the end of the pipe containing the gasket that is to be inspected (or alternatively, x-ray scanner 100 is stationary and axial rotation apparatus 200 is on rollers that are rolled toward x-ray scanner 100). Cantilever 160 extends into the lumen of the pipe while collimator 140 remains below the outer surface of the pipe. X-ray energy generated by x-ray generator 120 passes through collimator 140, which directs the beams through the wall of the pipe and to the x-ray sensor that is mounted on detector board 150. Rollers 220 rotate the pipe as generator 120 sends x-ray energy through the wall of the pipe and also through gasket, which can be on the inner wall of the pipe or the outer wall of the pipe. Either way, a radiographic image of the gasket will be generated, showing the outer edges of the gasket. The image will also identify whether the gasket has any anomalies and also whether the gasket is positioned correctly is perfectly straight within the inner wall or on the outer wall.

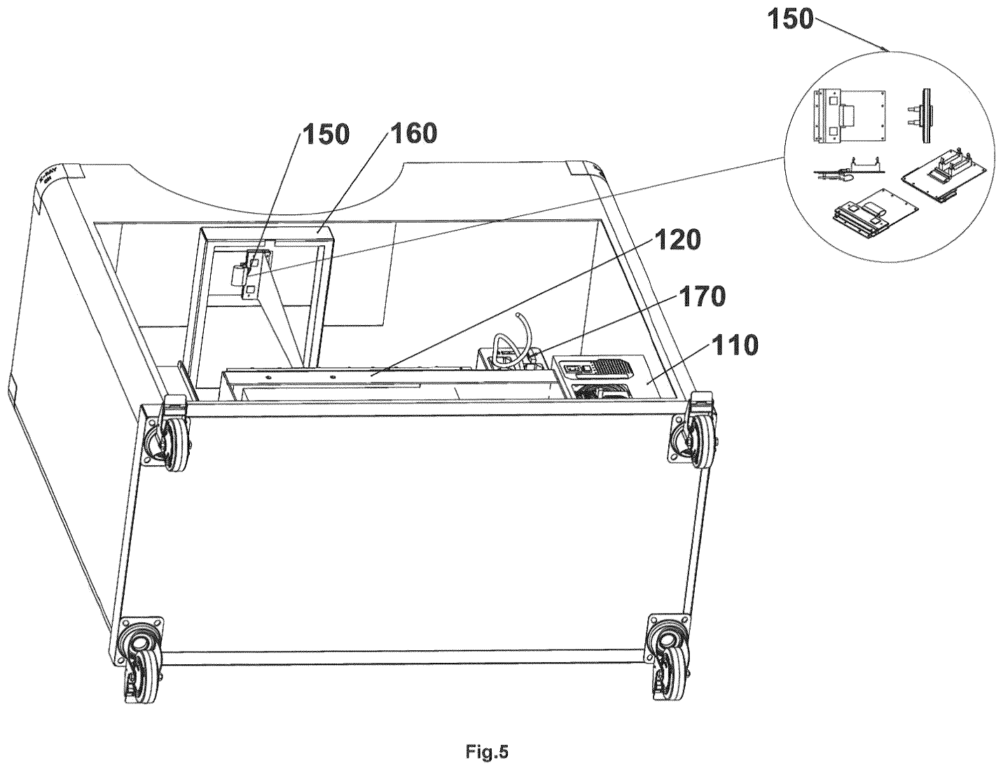

FIG. 5 shows the x-ray scanner 100 again with the wall off so that the inner components are visible, and in the view is taken from the bottom of x-ray scanner 100, looking up toward the bottom of cantilever 160 and the bottom of detector board 150. Detector board 150 can include a gasket finder, such as a laser beam or other light source that shines a beam of light on the inner surface of the pipe being inspected. Once the laser beam or light reaches the gasket, any further movement of the x-ray scanner 100 carriage relative to the axial rotation apparatus 200 ceases. This can be automated or it can be manual. In other words, placement of the pipe is determined by the gasket finder. If the gasket to be inspected is on the outer wall of the pipe, then the gasket finder can be located on the inside of the carriage, pointing a laser beam or other light source toward the outer wall of the pipe. As the pipe is brought into the hemispherical cut-out opening 190 of x-ray scanner 100 and advanced toward the back wall of x-ray scanner, the laser beam or light will eventually hit the gasket. When that happens, any further movement of the x-ray scanner 100 carriage relative to the axial rotation apparatus 200 ceases. This can be automated or it can be manual.

In one embodiment, a kit includes x-ray scanner 100, axial rotation apparatus 200, and instructions for use that include the following steps:
i. Place a pipe to be inspected on rollers of the axial rotation apparatus;
ii. Advance the axial rotation apparatus toward the x-ray scanner;
iii. Position an end of the pipe containing a gasket to be inspected in a hemispherical cut-out in the x-ray scanner;
iv. Position a cantilever containing an x-ray sensor into the lumen of the pipe with the x-ray sensor pointing towards the inner wall of the pipe;
v. Position the end of the pipe so that the gasket is just below the x-ray sensor and above the x-ray generator source found within the x-ray scanner;
vi. Turn on the x-ray generator source using the control panel of the x-ray scanner (the control panel may be in a remote location and communicating with the x-ray generator and the axial rotation apparatus;
vii. Turning on the rollers of the axial rotation apparatus and spinning the pipe while emitting x-ray energy toward the gasket of the pipe
viii. Displaying a radiographic image of the gasket of the pipe on a display communicating with the control panel;
ix. Storing image data of the gasket for later review
x. Turning off the x-ray generator after the pipe has rotated 360° (this can be automatic or manual)
xi. Analyzing the image data for anomalies in the gasket or imperfections in the placement of the gasket.

One embodiment includes a method of scanning gaskets on pipes, including the following steps:
i. Providing an x-ray scanner comprising a front side and a back side, wherein the back side has a hemispherical cut-out sized to receive an end of a pipe, said x-ray scanner further comprising an x-ray generator source pointing upwards toward a cantilever, said cantilever comprising a detector board with an x-ray sensor that is above the x-ray generator source, wherein there is sufficient space in between the x-ray generator source and the detector board to receive a wall of a pipe with the cantilever extending inside a lumen of the pipe and the x-ray generator being outside an outer wall of the pipe and pointing upwards toward the wall of the pipe;
ii. providing an axial rotation apparatus having rollers;
iii. placing a pipe having a gasket to be inspected on the rollers of the axial rotation apparatus;
iv. placing an end of the pipe containing a gasket to be inspected inside the hemispherical cut-out of the x-ray scanner;
v. positioning the gasket below the x-ray sensor on the detector board on the cantilever and above the x-ray generator source;
vi. turning on the x-ray generator source of the x-ray scanner;
vii. turning on the rollers so that the rollers spin the pipe;
viii. imaging the gasket as the pipe spins;
ix. turning off the rollers after the pipe has spun 360°;
x. recording radiographic images of the entirety length of the gasket;
xi. analyzing the images for anomalies in the gasket or incorrect placement of the gasket in the lumen of the pipe.

While the is susceptible to various modifications and alternative forms, specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives falling within the spirit and scope of the appended claims.

1. An x-ray scanner for non-destructive inspection of a pipe, the x-ray scanner comprising a housing with a front side, and a back side, the back side having a hemispherical cut-out opening sized to receive an open end of a pipe, wherein the housing contains therein;
an x-ray generator, with a collimator connected to it that extends upward from the x-ray generator and directs x-ray energy upward;
a computer that controls the operation of the x-ray scanner,
a cantilever extending from the top of a support structure, wherein the cantilever has mounted on its bottom side an x-ray detector board including an x-ray sensor, and wherein the cantilever is positioned in the hemispherical cut-out, and a top of the collimator is below the cantilever and aligned with the x-ray sensor on the detector board, wherein the collimator directs x-ray energy to the x-ray sensor on the x-ray detector board, and wherein there is a space in between the bottom of the cantilever and the top of the collimator for receiving an open end of the pipe, with said space being large enough to receive a wall of the pipe, such that energy emitted by the x-ray generator is transmitted through the wall of the pipe and is received by the x-ray sensor on the bottom of the cantilever, said x-ray sensor being positioned inside the lumen of the pipe just above a gasket encircling the inner wall of the pipe; and
a computer, wherein the detector board is in communication with the computer, the computer comprising software that converts data received from the detector board into radiographic x-ray images of the gasket being inspected.

2. An x-ray scanning system for non-destructive inspection of gaskets on pipes, the x-ray scanning system comprising:
an axial rotation apparatus comprising a support structure, rollers, and a motor that operates the rollers; and
an x-ray scanner comprising a housing with a front side, and a back side, the back side having a hemispherical cut-out opening sized to receive an open end of a pipe, wherein the housing contains therein;
an x-ray generator, with a collimator connected to it that extends upward from the x-ray generator and directs x-ray energy upward;
a computer that controls the operation of the x-ray scanner,
a cantilever extending from the top of a support structure, wherein the cantilever has mounted on its bottom side an x-ray detector board including an x-ray sensor, and wherein the cantilever is positioned in the hemispherical cut-out, and a top of the collimator is below the cantilever and aligned with the x-ray sensor on the detector board, wherein the collimator directs x-ray energy to the x-ray sensor on the x-ray detector board, and wherein there is a space in between the bottom of the cantilever and the top of the collimator for receiving an open end of the pipe, with said space being large enough to receive a wall of the pipe, such that energy emitted by the x-ray generator is transmitted through the wall of the pipe and is received by the x-ray sensor on the bottom of the cantilever, said x-ray sensor being positioned inside the lumen of the pipe just above a gasket encircling the inner wall of the pipe; and
a computer, wherein the detector board is in communication with the computer, the computer comprising software that converts data received from the detector board into radiographic x-ray images of the gasket being inspected.
